(19) United States
(12) Patent Application Publication
(10) Pub. No.: US 2010/0266138 A1
(43) Pub. Date: Oct. 21, 2010

(54) Device and method for active sound damping in a closed interior space

(75) Inventors: Delf Sachau, Hamburg (DE); Harald Breitbach, Hamburg (DE); Thomas Kletschkowski, Hamburg (DE); Sten Bohme, Kiel (DE); Kay Kochan, Hamburg (DE)

Correspondence Address: NIXON & VANDERHYE, PC, 901 NORTH GLEBE ROAD, 11TH FLOOR, ARLINGTON, VA, 22203, US

(73) Assignee: Airbus Deutschland GmbH,, Hamburg (DE)

(21) Appl. No.: 12/073,464

(22) Filed: Mar. 5, 2008

Related U.S. Application Data
(60) Provisional application No. 60/894,463, filed on Mar. 13, 2007.

(51) Int. Cl. H04R 3/02

(52) U.S. Cl. 381/73.1

(57) ABSTRACT

The invention relates to a method and device for active sound damping in a closed interior space (1) having an external wall which comprises at least one wall section (3, 4) with a primary sound source (6) which emits a primary sound signal induced by an interference signal (5), with at least one secondary sound generator (7; 12) in the interior space for generating a secondary sound signal, at least one sound pick-up device (10) in the interior space for detecting a sound signal in the interior space and a control device (8) which is connected to the at least one secondary sound generator (7; 12) and to the at least one sound pick-up device (10) and which controls the at least one secondary sound generator in dependence on the output signal of the at least one sound pick-up device so that the secondary sound signal is positioned substantially complementary to the primary sound signal.

In order to achieve in closed interior spaces an active sound damping which is effective over a wide frequency range as well as under different acoustic conditions it is proposed according to the invention to identify the or each transmission path of the interference signal and to arrange the at least one secondary sound generator (7; 12) in the or each transmission path of the interference signal so that the dispersion direction of the secondary sound signal will lie substantially identical with the dispersion direction of the primary sound signal into the closed interior space.

The invention relates to a method and a device for active sound damping in a closed interior space according to the preamble of claim 1 and according to the preamble of claim 5, respectively.

In many technical applications standing wave fields are induced in interior spaces through machine noise, propeller noise or other interference, more particularly in the low-frequency range with frequencies below about 500 Hz. These interferences are also difficult to compensate.

As a result of noise protection regulations or in order to increase the comfort it can be necessary to resort to suitable measures for noise abatement. At the present day there are numerous passive and active measures available. Active systems when used in the region of low frequencies enable a considerable weight and space saving, but the effective use of active counter sound systems in interior spaces is linked with high expense for positioning the actuators and sensors, see e.g. S. J. Elliot, “Signal processing for active control”, Academic Press, San Diego, Calif. 2001. The components of the sound compensation system used (Active Noise System or Anti Noise System, ANS) must for a global regulating success as a rule likewise be globally distributed in interior spaces.

With the prior art a number of proposals for the active “global” noise reduction in interior spaces are known.

If the volume to be quietened down is excited from outside then it is possible with the aid of natural mode analysis to trace back the vibration state to several natural frequencies. Secondary sources are thus now placed so that they can launch into the natural modes and thus eliminate these with destructive interference. With this method it is indeed possible to achieve good results but a pre-requirement of this method is that the natural frequencies can be calculated which is linked with high expense in the case of complicated internal space geometries. Furthermore with large volumes or high frequencies the natural frequencies are close together, this means that a correspondingly large number of secondary sources are required to suppress the natural modes. In addition this method requires a large number of globally distributed sensors.

Another method for solving the positioning problem of actuators and sensors is based on the use of suitable optimizing algorithms. One such method was described by C. Gerner in “Optimum active noise reduction in aircraft cabins for high tonal noise levels”, Dissertation, Helmut Schmidt University/University of Bundeswehr Hamburg, Hamburg, 2005. Instead of analysing the natural modes speakers and microphones are placed at all available positions. The transmission behaviour from each speaker to each microphone is then measured. In addition to this the primary noise which is to be eliminated is detected at the microphones. From this measurement data the best possible configuration of speakers and microphones is then calculated in an optimizing method from the available positions in order to achieve the maximum reduction of primary noise.

The “acoustic curtain” proposed in DE 10 2005 016 021 A1 of 7 Apr. 2005 describes a sound compensation system whose actuators are arranged around the open boundary surface area of a half-closed control volume. With this arrangement a global noise reduction is to be achieved in the control volume. Use for closed spaces is however not possible since in particular the global positioning problem of the microphones remains unsolved.

In DE 198 32 517 a method is described for active sound damping in a duct through which a medium can flow. By means of a compensation speaker in dependence on signals of a reference microphone and an error microphone a counter sound is generated to compensate for the primary sound. Through coherence measurement the frequencies or frequency ranges are determined in which the signals measured by means of the reference microphone and the error microphone exceed a predeterminable coherence degree, and these signals are taken into consideration during further signal processing.

Furthermore in DE 21 39 941 a noise shield is described which comprises a sound grid which comprises anti-sound generator systems. The anti-sound generators are thereby controlled by microphones so that their radiated sound pressure signal behaves both in proportion to the negative pressure signal of the noise source at the site of the relevant anti-sound generator and also proportional to the cosine of the angle of the incoming noise beam to the normal of the sound grid and furthermore proportional to the mesh surface of the grid.

All the methods described above require an immense outlay in order to be able to place the speakers and microphones of a sound compensation system in the optimum positions. If however the frequency of the primary sound or the acoustic properties of the interior space change then such systems can suffer very considerably in their efficiency or even will no longer work at all.

The object of the present invention is therefore to show a method and provide a device with which it is possible to obtain in closed interior spaces an active sound damping which acts over a wide frequency range and under different acoustic conditions.

This is achieved through the method and device for active sound damping in closed interior spaces according to claim 1 and claim 5 respectively. Preferred embodiments of the invention form the subject of the relevant dependent claims.

According to the invention an active acoustic barrier is provided on the surface at which the interference sound coming from outside is launched into the interior space in question. If secondary sound generators are arranged locally on this surface area, i.e. directly in the critical transmission path, then by means of destructive interference it is possible to obtain a global regulating success in the relevant interior space.

The method according to the invention for the active sound damping in a closed interior space having an outside wall which comprises at least one wall section with a primary sound source, which radiates a primary sound signal induced by an interference signal, with at least one secondary sound generator in the interior space for generating a secondary sound signal, at least one sound pick-up device in the interior space for detecting a sound signal in the interior space and a control device which is connected to the at least one secondary sound generator and to the at least one sound pick-up device and which controls the at least one secondary sound generator in dependence on the output signal of the at least one sound pick-up device so that the secondary sound signal is positioned substantially complementary to the primary sound signal, is characterised by the steps: identifying the or each transmission path of the interference signal and arranging the at least one secondary sound generator in the or each transmission path of the interference signal so that the dispersion direction of the secondary sound signal will lie substantially identical with the dispersion direction of the primary sound signal into the closed interior space.

In particular the method according to the invention has one or—where technically possible and advisable—several of the following natural types, namely:

the at least one secondary sound generator is arranged next to and/or in the wall section with the primary sound source;
several secondary sound generators are arranged in matrix form or
several sound pick-up devices are arranged in matrix form.

Analogously a device for active sound damping in a closed interior space having an outside wall which comprises at least one wall section with a primary sound source which emits a primary sound signal induced by an interference signal, is provided with at least one secondary sound generator in the interior space for generating a secondary sound signal, at least one sound pick-up device in the interior space for detecting the sound signal in the interior space and a control device which is connected to the at least one secondary sound generator and to the at least one sound pick-up device and which controls the at least one secondary sound generator in dependence on the output signal of the at least one sound pick-up device so that the secondary sound signal is positioned substantially complementary to the primary sound signal, which is characterised in that the at least one secondary sound generator is mounted next to and/or in the wall section with the primary sound source so that the dispersion direction of the secondary sound signal is substantially identical with the dispersion direction of the primary sound signal into the closed interior space.

One advantage of the sound compensation arrangement according to the invention is that through the direct arrangement of the “active acoustic barrier” in the transmission path the positioning problem is solved. On the other hand the performance efficiency of the system is not affected by changes in the air volume which is to be calmed down. Furthermore the sound compensation arrangement can not only be used in interior spaces but it is also effective under free-field conditions.

Further advantages and features of the invention are apparent from the following description of preferred embodiments wherein reference is made to the accompanying drawing.

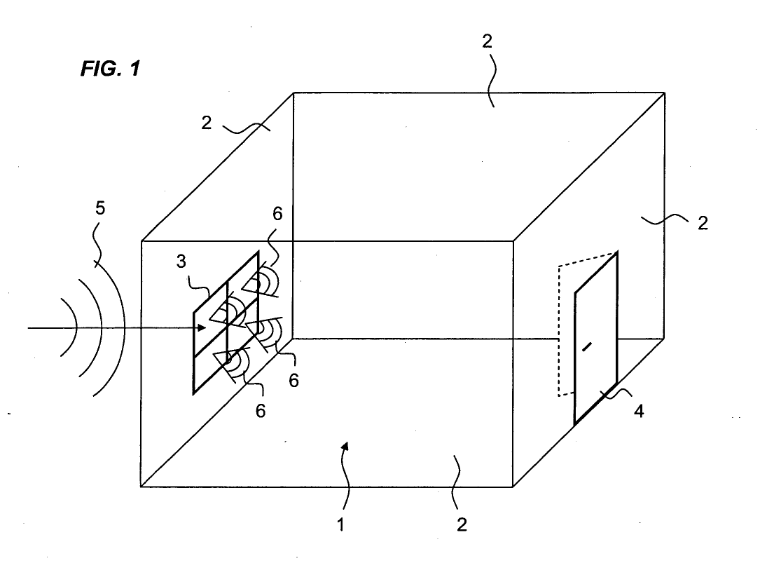

FIG. 1 shows a diagrammatic illustration of the starting situation with interference noise which is launched into an interior space through a window.

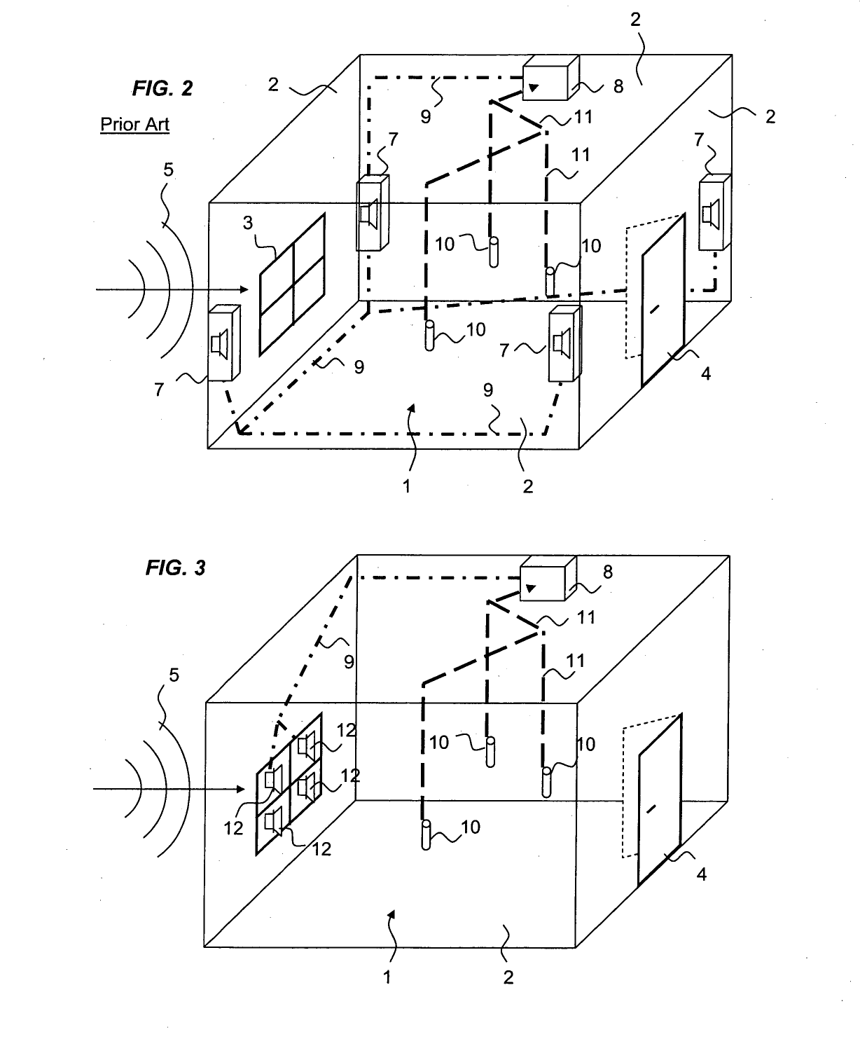

FIG. 2 shows a diagrammatic illustration of an interference noise compensation according to the prior art.

FIG. 3 shows a diagrammatic illustration of an interference noise compensation according to the invention.

FIG. 1 shows diagrammatically a situation in which interference noise is launched into an interior space 1. The interior space 1 is defined by external walls 2. In the external walls 2 there are wall sections 3 and 4 through which a stronger acoustic coupling of the interior space 1 to the surroundings takes place. These wall sections are in particular windows and doors as shown in FIG. 1. The efficiency of the acoustic coupling thereby depends on the dispersion direction of the sound and on the composition of same, i.e. on its frequency spectrum. These two aspects are not considered further in the following, here it only starts from the fact that the interference noise is launched into the interior space 1 through the wall section 3, i.e. the window, but not however through the wall section 4, the door. The wall section 3 can thus be regarded as the new primary sound source, and the dispersion conditions of the sound outside of the interior space 1 can remain disregarded.

As indicated the wall section 3 in the illustrated example can be divided into several individual sources 6. In the illustration these are the individual elements of a divided window. In general any surface area emitting sound can be understood as comprised of spot sources.

FIG. 2 shows an attachment for compensating the interference sound in the interior space 1 according to the prior art. For clarity the individual sources 6 were not shown. A sound compensation system according to the prior art consists essentially of a spatial arrangement of speakers (actuators) and error microphones (sensors) which are connected to a digital regulator. The noise which is to be attenuated, also called primary sound, is superimposed with the generated sound field (secondary noise) of the speakers. The error microphones measure the sound pressure level resulting therefrom. This data is processed by the digital regulator and the speaker is controlled so that the sound pressure level at the sensors is minimal. A noise reduction is thereby locally achieved at the microphone positions.

The interference sound, which in FIG. 2 spreads from the wall section 3 into the interior space, leads to a primary sound field in the interior space 1. This sound field is compensated in that a secondary sound field is built up from the secondary sound generators 7 and when superimposed on the primary sound field cancels the latter out so that the room becomes “calmed”. In order to be able to generate the secondary sound field the primary sound field is detected by sound pick-ups 10 which are spread out in the interior space. The signal of the sound pick-up 10 is directed via the connecting cable 11 to a control device 8. This control device 8 analyses the detected primary sound field signal according to intensity, frequency and local distribution. Using these parameters secondary sound field signals are then generated by the control device 8 and sent via connecting lines 9 to several secondary sound generators 7 in the interior space 1. These secondary sound generators 7 are distributed around the interior space 1 so that they can generate a secondary sound field which is as complete as possible for compensating the primary sound field.

The problem which cannot be solved with this attachment according to the prior art is that the generation of the secondary sound field depends on the concrete geometrical conditions of the interior space 1. This applies moreover to a similar extent for detecting the primary sound field. In other words as soon as the geometric conditions of the interior space change the arrangement of the secondary sound generators 7 is no longer sufficient for complete compensation of the primary sound.

This problem is solved through the special arrangement of the secondary sound generators according to the present invention which is explained below with reference to FIG. 3. FIG. 3 shows essentially the same elements as FIG. 2 except for the secondary sound generators 7 with the connecting lines 9, as are known in the prior art.

To proceed with the arrangement of the secondary sound generators, according to the invention first the or each transmission path of the interference signal into the interior space is identified. This can be carried out preferably with the sound pick-up devices 10 which are required for generating the secondary sound signal. However equally well can be used sound pick-ups provided especially for this and which are not shown in the drawing and will not be explained in further detail here. In the illustrated case this means that the window 3 is recognised as the primary sound source. Next according to the invention at least one secondary sound generator is then positioned in the transmission path of the interference signal itself. This positioning of the secondary sound generator takes place so that the dispersion direction of the secondary sound signal is substantially identical with the dispersion direction of the primary sound signal into the closed interior space.

For this it is necessary that the secondary sound generators are adapted to the spatial conditions, i.e. that an arrangement in the transmission path of the interference sound itself is indeed possible. Instead of the hitherto conventional speakers 7 as secondary sound generators are therefore according to the invention special sound generators 12 used which can be fitted by way of example to window surfaces without impairing the function of the component. In the special case of a window in particular piezo surface crystals can be used which do not restrict the optical transparency. Analogous with the prior art these special sound generators 12 are controlled through connecting lines 9 by the control device 8.

The arrangement of the special sound generators 12 is not restricted to their being positioned in the transmission path of the interference noise itself. Furthermore the secondary sound generators 12 can obviously also be arranged directly adjacent the wall section 3 with the primary sound source 6, so long as it is ensured that the dispersion direction of the secondary sound signal is substantially identical with the dispersion direction of the primary sound signal into the closed interior space.

It is thereby particularly advantageous if when using several secondary sound generators 12 these are arranged in matrix form.

As already indicated above this applies to the same extent for the sound pick-up devices 10. In other words, if several sound pick-up devices 10 are used then these are preferably arranged in matrix form.

It is obvious to the person skilled in the art that the method explained using FIG. 3 for the active sound damping in a closed interior space 1 leads to a device which comprises the said components. The device accordingly comprises several secondary sound generators 12 in the interior space 1 for generating a secondary sound signal. The control device 8 which is connected to the secondary sound generator 12 and to the sound pick-up devices 10 controls the secondary sound generators 12 in dependence on the output signal of the sound pick-up devices 10 so that the secondary sound signal is substantially complementary with the primary sound signal. The secondary sound generators 12 are thereby arranged next to or in the wall section 3 and where necessary 4 in which the primary sound source 6 is located so that the dispersion direction of the secondary sound signal is substantially identical with the dispersion direction of the primary sound signal into the closed interior space 1.

With the invention it is thus possible in the case of a primary source in an interior space with an equal size secondary source which has the same emitting characteristic to cancel out globally the noise penetrating into the interior space.

Particularly in the case of aircraft, but also in the case of other vehicles, the global distribution of system components in the interior space is problematical as a result of structural and design requirements. In many cases however the mostly stationary harmonic interference noise is transmitted over a restricted number of transmission paths into the interior space. This means that the interference primary sound in most technical applications passes only over a small number of transmissions paths into the interior space which is to be quietened down. These transmission paths can for example contain openings or vibrating structures. These systems are thus particularly suitable for the use of the method according to the invention and the device according to the invention, independently of whether the interior space is excited through air noise or body noise.

### REFERENCE NUMERALS

1 Interior space
2 Outside wall
3 First wall section with primary sound source
4 Second wall section with primary sound source
5 Excitation sound
6 Primary sound source(s)
7 Secondary sound generator
8 Control device
9 Connection secondary sound generator—control device
10 Sound pick-up device
11 Connection sound pick-up device—control device
12 Local sound sources

1. Method for active sound damping in a closed interior space (1) having an exterior wall (2) which comprises at least one wall section (3, 4) with a primary sound source (6) which emits a primary sound signal induced by an interference signal (5), with
at least one secondary sound generator (7; 12) in the interior space (1) for generating a secondary sound signal,
at least one sound pick-up device (10) in the interior space for detecting a sound signal in the interior space (1) and
a control device (8) which is connected to the at least one secondary sound generator (7; 12) and to the at least one sound pick-up device (10) and which controls the at least one secondary sound generator (7; 12) in dependence on the output signal of the at least one sound pick-up device (10) so that the secondary sound signal is positioned substantially complementary with the primary sound signal,
characterised by the steps:
identifying the or each transmission path of the interference signal (5) and arranging the at least one secondary sound generator (7; 12) in the or each transmission path of the interference signal (5) so that the dispersion direction of the secondary sound signal will lie substantially identical with the dispersion direction of the primary sound signal into the closed interior space.

2. Method according to claim 1
in which the at least one secondary sound generator (7; 12) is arranged next to and/or in the wall section (3, 4) with the primary sound source (6).

3. Method according to claim 1 in which several secondary sound generators (7; 12) are arranged in matrix form.

4. Method according to one of claims 1 to 3 in which several sound recording devices (10) are arranged in matrix form.

5. Device for active sound damping in a closed interior space (1) having an external wall which comprises at least one wall section (3, 4) with a primary sound source (6) which emits a primary sound signal induced by an interference signal (5), with at least one secondary sound generator (7; 12) in the interior space for generating a secondary sound signal,
at least one sound pick-up device (10) in the interior space for detecting the sound signal in the interior space and
a control device (8) which is connected to the at least one secondary sound generator (7; 12) and to the at least one sound pick-up device (10) and which controls the at least one secondary sound generator (7; 12) in dependence on the output signal of the at least one sound pick-up device (10) so that the secondary sound signal is positioned substantially complementary to the primary sound signal,
characterised in that the at least one secondary sound generator (7, 12) is arranged next to and/or in the wall section (3, 4) with the primary sound source (6) so that the dispersion direction of the secondary sound signal is substantially identical with the dispersion direction of the primary sound signal into the closed interior space (1).
